(19) United States
(12) Patent Application Publication
(10) Pub. No.: US 2022/0049071 A1
(43) Pub. Date: Feb. 17, 2022

(54) FIBROUS CELLULOSE COMPOSITE RESIN AND METHOD FOR MANUFACTURING THE SAME

(71) Applicant: Daio Paper Corporation, Ehime (JP)

(72) Inventors: Ikko Matsusue, Ehime (JP); Yu Ochiai, Ehime (JP)

(73) Assignee: Daio Paper Corporation, Ehime, OT (JP)

(21) Appl. No.: 17/275,456

(22) PCT Filed: Oct. 28, 2019
(86) PCT No.: PCT/JP2019/042124

§ 371 Date: Mar. 11, 2021

(30) Foreign Application Priority Data
Oct. 31, 2018 (JP) 2018-205970
Oct. 31, 2018 (JP) 2018-205971

(51) Int. Cl. C08L 1/02; C08L 23/26; C08K 5/12

(52) U.S. Cl. CPC C08L 1/02; C08K 5/12; C08L 23/26

(57) ABSTRACT

To provide a fibrous cellulose composite resin having excellent strength, particularly excellent flexural modulus, and having no coloring problem, and a method for manufacturing the same. A fibrous cellulose composite resin contains: microfiber cellulose having an average fiber width of 0.1 μm or more; a resin; and a polybasic acid salt. In addition, the raw material fibers are defibrated into microfiber cellulose within a range where the microfiber cellulose has an average fiber width of 0.1 μm or more, and this microfiber cellulose, a resin, and a polybasic acid salt are kneaded to manufacture a fibrous cellulose composite resin.

### TECHNICAL FIELD

The present invention relates to a fibrous cellulose composite resin and a method for manufacturing the same.

### BACKGROUND ART

In recent years, various proposals have been made to use cellulose nanofibers (CNF) as a reinforcing material for a resin. However, the cellulose nanofibers irreversibly aggregate due to an intermolecular hydrogen bond derived from a hydroxyl group of a polysaccharide. Therefore, even when the cellulose nanofibers are used as a reinforcing material for a resin, a resin reinforcing effect is not sufficiently exhibited because of poor dispersibility of the cellulose nanofibers in the resin.

Therefore, for example, Patent Literature 1 proposes a polyolefin resin composition characterized by containing a terpenephenol-based compound as a compatibilizer with respect to a resin mixture of cellulose nanofibers having an average thickness of 10 to 200 nm and a polyolefin resin. Patent Literature 1 describes that inclusion of terpenephenol improves dispersibility of the cellulose nanofibers (see, for example, paragraph 0038 and the like). However, it is questionable whether the inclusion of terpenephenol sufficiently improves the dispersibility of the cellulose nanofibers, and a proposal for a compatibilizer substituting for terpenephenol is also expected.

For example, Patent Literature 2 proposes a method of esterifying cellulose with a base catalyst or an acid catalyst and a dibasic carboxylic acid anhydride to obtain cellulose fine fibers. Patent Literature 2 describes that introduction of a fluorene compound into the obtained cellulose fine fibers can improve affinity for an organic medium such as a resin. However, the method of Patent Literature 2 uses a base catalyst or an acid catalyst, is performed under harsh reaction conditions, and therefore causes a cellulose fiber coloring problem.

Furthermore, for example, Patent Literature 3 proposes a resin composition in which cellulose fibers having an average fiber diameter of 4 to 400 nm are complexed with a modified olefinic polymer. For example, Patent Literature 4 proposes a composition containing a polymer compound having a primary amino group, a polymer compound modified with maleic anhydride, nano-level microfibrillated plant fibers, and a polyolefin. Furthermore, for example, Patent Literature 5 proposes a resin composition containing: modified microfibrillated plant fibers esterified with alkylsuccinic anhydride or alkenylsuccinic anhydride, and defibrated to a nano level; a thermoplastic resin; and an inorganic salt.

However, as recognized by the present inventors, by any of the above methods, dispersibility of cellulose fibers is not sufficient, the cellulose fibers do not form a three-dimensional network, and a resin reinforcing effect is not sufficient.

### CITATION LIST

### Patent Literature

Patent Literature 1: JP 2016-79311 A

Patent Literature 2: JP 2017-82188 A

Patent Literature 3: JP: 5433949 B2

Patent Literature 4: JP: 5717643 B2

Patent Literature 5: JP: 5757765 B2

### SUMMARY OF INVENTION

### Technical Problem

A main problem to be solved by the present invention is to provide a fibrous cellulose composite resin having excellent strength, particularly excellent flexural modulus, and having no coloring problem, and a method for manufacturing the same.

### Solution to Problem

In order to solve the above problems, the present inventors have performed various treatments on cellulose nanofibers, and have sought a method for kneading cellulose nanofibers with a resin. That is, as in Patent Literatures 1 to 5, based on use of cellulose nanofibers, the present inventors repeatedly improved various materials to be mixed with cellulose nanofibers, and attempted various modifications of cellulose nanofibers.

However, even when the cellulose nanofibers were hydrophobically modified, dispersibility thereof in a resin was not sufficient, it was difficult to form a three-dimensional network of the cellulose nanofibers in the resin, a resin composition having sufficient strength could not be obtained, and a sufficient resin reinforcing effect could not be obtained.

However, in the process of the studies, the present inventors have found that in a case of using microfiber cellulose as raw material fibers, dispersibility thereof in a resin is favorable, a three-dimensional network of the microfiber cellulose is formed in the resin, and a sufficient resin reinforcing effect is obtained. In addition, based on this finding, the present inventors have conceived of a fibrous cellulose composite resin in which the dispersibility of the fibrous cellulose is further improved to improve the strength of the resin, and in addition, which solves a coloring problem, and a method for manufacturing the same. Specifically, the present inventors have conceived of the means to be described below.

Note that the above Patent Literature 4 describes “in the present invention, the microfibrillated plant fibers preferably have an average fiber diameter of 4 nm to 50 μm”. However, although it is clear that Patent Literature 4 intends cellulose nanofibers, it is unlikely that Patent Literature 4 intends a microfiber cellulose, and the average fiber diameter is 4 nm to 50 μm, the range of which is too wide. Therefore, it is difficult for not only the present inventors but also ordinary inventors to derive a fact that microfiber cellulose is preferable only from this description.

(Means Recited in Claim 1)

A fibrous cellulose composite resin containing:

microfiber cellulose having an average fiber width of 0.1 μm or more; a resin; and a polybasic acid salt.

(Means Recited in Claim 2)

The fibrous cellulose composite resin according to claim 1,

wherein the microfiber cellulose has an average fiber length of 0.02 to 3.0 mm and a percentage of fibrillation of 1.0 to 30%.

(Means Recited in Claim 3)

The fibrous cellulose composite resin according to claim 1 or 2,

wherein the polybasic acid salt is at least one of a phthalate and a derivative of a phthalate.

(Means Recited in Claim 4)

The fibrous cellulose composite resin according to claim 3,

wherein the phthalate is at least one selected from the group consisting of potassium hydrogen phthalate, sodium hydrogen phthalate, sodium phthalate, and ammonium phthalate.

(Means Recited in Claim 5)

The fibrous cellulose composite resin according to any one of claims 1 to 4,

wherein a part of the polybasic acid salt has modified the microfiber cellulose.

(Means Recited in Claim 6)

A method for manufacturing a fibrous cellulose composite resin, the method including:

defibrating raw material fibers into microfiber cellulose within a range where the microfiber cellulose has an average fiber width of 0.1 μm or more; and

kneading this microfiber cellulose, a resin, and a polybasic acid salt.

(Means Recited in Claim 7)

The fibrous cellulose composite resin according to claim 1, containing

maleic anhydride-modified polypropylene.

(Means Recited in Claim 8)

The fibrous cellulose composite resin according to claim 7,

wherein the ratio of the maleic anhydride-modified polypropylene with respect to 100 parts by mass of the microfiber cellulose is 0.1 to 1000 parts by mass.

(Means Recited in Claim 9)

The fibrous cellulose composite resin according to claim 1, containing

at least one selected from the group consisting of a polybasic acid, a derivative of a polybasic acid, and a derivative of a polybasic acid salt.

(Means Recited in Claim 10)

The fibrous cellulose composite resin according to claim 9,

wherein the microfiber cellulose is modified with any of the polybasic acid, the derivative of polybasic acid, and the derivative of polybasic acid salt.

(Means Recited in Claim 11)

The fibrous cellulose composite resin according to claim 9,

in which the polybasic acid is phthalic acid, and the polybasic acid salt is a phthalate.

### ADVANTAGEOUS EFFECTS OF INVENTION

The present invention provides a fibrous cellulose composite resin having excellent strength, particularly excellent flexural modulus, and having no coloring problem, and a method for manufacturing the same.

### DESCRIPTION OF EMBODIMENTS

Next, an embodiment for carrying out the invention will be described. Note that the present embodiment is an example of the present invention. The scope of the present invention is not limited to the scope of the present embodiment.

The fibrous cellulose composite resin of the present embodiment contains: microfiber cellulose having an average fiber width of 0.1 μm or more; a resin; and polybasic acid salts. For obtaining this fibrous cellulose composite resin, raw material fibers are defibrated into microfiber cellulose having an average fiber width of 0.1 μm or more, and this microfiber cellulose, a resin, and polybasic acid salts are kneaded to obtain a fibrous cellulose composite resin containing the polybasic acid salts.

Furthermore, the fibrous cellulose composite resin of the present embodiment preferably contains maleic anhydride-modified polypropylene (MAPP). The fibrous cellulose composite resin of the present embodiment more preferably contains at least one additive selected from the group consisting of polybasic acids, derivatives of polybasic acids, and derivatives of polybasic acid salts. The fibrous cellulose composite resin of the present embodiment particularly preferably contains at least one second additive selected from the group consisting of ethylene glycol, derivatives of ethylene glycol, ethylene glycol polymers, and derivatives of ethylene glycol polymers. For obtaining the fibrous cellulose composite resin, for example, raw material fibers are defibrated into microfiber cellulose having an average fiber width of 0.1 μm or more, and the microfiber cellulose, a resin, maleic anhydride-modified polypropylene, the above-described additive, and the like are kneaded to obtain a fibrous cellulose composite resin containing maleic anhydride-modified polypropylene. Hereinafter, description will be made in order.

(Raw Material Fibers)

Microfiber cellulose (MFC) may be obtained by micronizing (defibrating) raw material fibers (pulp fibers). As the raw material fibers, one or more kinds may be selected for use from the group consisting of plant-derived fibers, animal-derived fibers, microorganism-derived fibers, and the like. However, pulp fibers, which are plant fibers, are preferably used. When the raw material fibers are pulp fibers, the pulp fibers are inexpensive and may avoid a problem of thermal recycling.

As the plant-derived fibers, one or more kinds may be selected for use from the group consisting of wood pulp made from hardwood, softwood, or the like, non-wood pulp made from straw, bagasse, or the like, and de-inked pulp (DIP) made from recovered used paper, waste paper, or the like.

As the wood pulp, one or more kinds may be selected for use from the group consisting of chemical pulp such as hardwood kraft pulp (LKP) or softwood kraft pulp (NKP), mechanical pulp (TMP), and de-inked pulp (DIP). These pulps are used for papermaking applications, and by using these pulps, existing facilities may be effectively utilized.

The hardwood kraft pulp (LKP) may be hardwood bleached kraft pulp, hardwood unbleached kraft pulp, or hardwood semibleached kraft pulp. Similarly, the softwood kraft pulp (NKP) may be softwood bleached kraft pulp, softwood unbleached kraft pulp, or softwood semibleached kraft pulp.

The de-inked pulp (DIP) may be magazine de-inked pulp (MDIP), newspaper de-inked pulp (NDIP), corrugated de-inked pulp (WP), or other de-inked pulp.

Furthermore, as the mechanical pulp, one or more kinds may be selected for use from the group consisting of, for example, stone ground pulp (SGP), pressure stone ground pulp (PGW), refiner ground pulp (RGP), chemiground pulp (CGP), thermoground pulp (TGP), ground pulp (GP), thermomechanical pulp (TMP), chemithermomechanical pulp (CTMP), refiner mechanical pulp (RMP), and bleached thermomechanical pulp (BTMP).

(Pretreatment Step)

The raw material fibers are preferably pretreated using a chemical method. By performing a pretreatment using a chemical method prior to a micronization (defibration) treatment, the number of times of the micronization treatment may be significantly reduced, and energy required for the micronization treatment may be significantly reduced.

Examples of the pretreatment using a chemical method include hydrolysis of polysaccharides with acid (acid treatment), hydrolysis of polysaccharides with enzyme (enzyme treatment), swelling of polysaccharides with alkali (alkali treatment), oxidation of polysaccharides with an oxidizing agent (oxidation treatment), and reduction of polysaccharides with a reducing agent (reduction treatment).

By performing an alkali treatment prior to the micronization treatment, a part of the hydroxyl groups of hemicellulose or cellulose included in pulp is dissociated, and the molecules are anionized to weaken the intramolecular and intermolecular hydrogen bonds, resulting in promoted dispersion of pulp fibers in the micronization treatment.

As the alkali, for example, organic alkali such as sodium hydroxide, lithium hydroxide, potassium hydroxide, an aqueous ammonia solution, tetramethylammonium hydroxide, tetraethylammonium hydroxide, tetrabutylammonium hydroxide, or benzyltrimethylammonium hydroxide may be used. However, sodium hydroxide is preferably used from a viewpoint of manufacturing cost.

When the enzyme treatment, acid treatment, or oxidation treatment is performed prior to the micronization treatment, the water retention degree of the microfiber cellulose may be lowered, the crystallinity may be increased, and the homogeneity may be increased. In this regard, it is considered that a lower water retention degree of the microfiber cellulose makes the dispersibility in the resin better, and a higher homogeneity of the microfiber cellulose makes defects that cause destruction of the resin composition less. As a result, it is considered that a composite resin having high strength capable of maintaining the ductility of the resin may be obtained. In addition, the enzyme treatment, the acid treatment, and the oxidation treatment decompose the amorphous region of hemicellulose or cellulose included in pulp. As a result, energy required for the micronization treatment may be reduced, and the homogeneity and dispersibility of fibers may be improved. Moreover, when the ratio of the cellulose crystal region, in which it is considered that molecular chains are aligned, rigidity is high, and a water retention degree is low, with respect to the entire fibers is increased, the dispersibility is improved and, though the aspect ratio may be reduced, a composite resin having high mechanical strength while the ductility is maintained may be obtained.

Among the above various treatments, the enzyme treatment is preferably performed, and one or more treatments selected from the group consisting of the acid treatment, the alkali treatment, and the oxidation treatment are more preferably performed in addition to the enzyme treatment. Hereinafter, the alkali treatment will be described in detail.

Examples of a method of the alkali treatment include a method for immersing the raw material fibers in an alkaline solution.

An alkali compound contained in the alkaline solution may be an inorganic alkali compound or an organic alkali compound.

Examples of the inorganic alkali compound include hydroxides of alkali metal or alkaline earth metal, carbonates of alkali metal or alkaline earth metal, and phosphorus oxoacid salts of alkali metal or alkaline earth metal.

Examples of the hydroxides of alkali metal include lithium hydroxide, sodium hydroxide, and potassium hydroxide. Examples of the hydroxides of alkaline earth metal include calcium hydroxide. Examples of the carbonates of alkali metal include lithium carbonate, lithium hydrogen carbonate, potassium carbonate, potassium hydrogen carbonate, sodium carbonate, and sodium hydrogen carbonate. Examples of the carbonates of alkaline earth metal include calcium carbonate. Examples of the phosphorus oxoacid salts of alkali metal include lithium phosphate, potassium phosphate, trisodium phosphate, and disodium hydrogen phosphate. Examples of the phosphates of alkaline earth metal include calcium phosphate and calcium hydrogen phosphate.

Examples of the organic alkali compound include ammonia, an aliphatic amine, an aromatic amine, an aliphatic ammonium, an aromatic ammonium, and a heterocyclic compound, and hydroxides, carbonates, and phosphates thereof. Specific examples of the organic alkali compound include ammonia, hydrazine, methylamine, ethylamine, diethylamine, triethylamine, propylamine, dipropylamine, butylamine, diaminoethane, diaminopropane, diaminobutane, diaminopentane, diaminohexane, cyclohexylamine, aniline, tetramethylammonium hydroxide, tetraethylammonium hydroxide, tetrapropylammonium hydroxide, tetrabutylammonium hydroxide, benzyltrimethylammonium hydroxide, pyridine, N,N-dimethyl-4-aminopyridine, ammonium carbonate, ammonium hydrogen carbonate, and diammonium hydrogen phosphate.

A solvent of the alkaline solution may be either water or an organic solvent, but is preferably a polar solvent (a polar organic solvent such as water or alcohol), and more preferably an aqueous solvent containing at least water.

The pH of the alkaline solution at 25° C. is preferably 9 or higher, more preferably 10 or higher, and particularly preferably 11 to 14. When the pH is 9 or higher, the yield of the microfiber cellulose (MFC) is high. However, when the pH exceeds 14, handleability of the alkaline solution decreases.

(Micronization (Defibration) Step)

The micronization treatment may be performed by beating the raw material fibers using, for example, a beater, a homogenizer such as a high-pressure homogenizer or a high-pressure homogenizing apparatus, a millstone friction machine such as a grinder or a mill, a single-screw kneader, a multi-screw kneader, or a kneader refiner, and the micronization treatment is preferably performed using a refiner.

The refiner is an apparatus for beating pulp fibers, and a known refiner may be used. As the refiner, a conical type, a double disc refiner (DDR), and a single disc refiner (SDR) are preferable from a viewpoint of efficiently applying shearing force to pulp fibers to promote preliminary defibration, or the like. Note that the refiner is preferably used in the defibration treatment step also from a viewpoint of eliminating separation and washing after the treatment.

Note that the microfiber cellulose is a fiber made of cellulose or a cellulose derivative. An ordinary microfiber cellulose has a strong hydration property and hydrates in an aqueous medium to stably maintain a dispersed state (dispersion state). A plurality of single fibers constituting the microfiber cellulose may aggregate in an aqueous medium to be in a fibrous form.

The micronization (defibration) treatment is performed in a range where the number average fiber diameter (fiber width, average diameter of single fibers) of the microfiber cellulose is preferably 0.1 μm or more, more preferably 0.1 to 15 μm, particularly preferably 0.1 to 9 μm. By performing the micronization (defibration) treatment in a range where the number average fiber diameter (width) is 0.1 μm or more, dispersibility of the cellulose fibers is improved, and the strength of the fibrous cellulose composite resin is improved.

Specifically, when the average fiber diameter is less than 0.1 μm, there is no difference from a case of using a cellulose nanofiber, and a reinforcing effect (particularly flexural modulus) may not be sufficiently obtained. In addition, the time required for the micronization treatment is long and a large amount of energy is required, which leads to increase in the manufacturing cost. Meanwhile, when the average fiber diameter exceeds 15 μm, the dispersibility of fibers tends to be poor. When the dispersibility of fibers is insufficient, the reinforcing effect tends to be poor. Furthermore, in a case where the average fiber diameter is less than 0.1 μm, when the fibrous cellulose in an aqueous dispersion state is mixed with polybasic acid salts or maleic anhydride-modified polypropylene, the viscosity is too high, and the mixture needs to be stirred at high shear, which is energetically disadvantageous. Moreover, stirring at high shear may cause the fibrous cellulose to be torn or deteriorated, for example.

The average fiber length (length of single fibers) of the microfiber cellulose is preferably 0.02 to 3.0 mm, more preferably 0.05 to 2.0 mm, and particularly preferably 0.1 to 1.5 mm. When the average fiber length is less than 0.02 mm, a three-dimensional network of the fibers may not be formed, and the reinforcing effect may be significantly reduced. Note that the average fiber length may be arbitrarily adjusted by, for example, selection, pretreatment, and defibration treatment of the raw material fiber.

The percentage of fibrillation of the microfiber cellulose is preferably 1.0% or more, more preferably 1.5% or more, and particularly preferably 2.0% or more. The percentage of fibrillation of the microfiber cellulose is preferably 30.0% or less, more preferably 20.0% or less, and particularly preferably 15.0% or less.

When the percentage of fibrillation exceeds 30.0%, the micronization progresses excessively to form nanofibers, and therefore the intended effect may not be obtained. In addition, in a case where the percentage of fibrillation exceeds 30%, when the fibrous cellulose in a form of an aqueous dispersion is mixed with the polybasic acid salts or the maleic anhydride-modified propylene, the viscosity is too high, and it is difficult to stir the mixture uniformly. Forcibly stirring even in such a situation may cause the fibrous cellulose to be torn or deteriorated, for example.

Meanwhile, when the percentage of fibrillation is less than 1.0%, there are few hydrogen bonds between fibrils, and a sufficient strong three-dimensional network may not be obtained. In this regard, the present inventors have found in the process of various tests that when the percentage of fibrillation of the microfiber cellulose is 1.0% or more, fibrils of the microfiber cellulose are hydrogen-bonded to each other to construct a stronger three-dimensional network.

The percentage of fibers each having a length of 0.2 mm or less in the microfiber cellulose is preferably 12% or more, more preferably 16% or more, and particularly preferably 26% or more. When the percentage is less than 12%, a sufficient reinforcing effect may not be obtained.

The percentage of fibers each having a length of 0.2 mm or less in the microfiber cellulose does not have an upper limit, and all the fibers may each have a length of 0.2 mm or less.

The aspect ratio of the microfiber cellulose is preferably 2 to 5000, and more preferably 100 to 1000 in order to improve the mechanical strength while the ductility of the resin is maintained to some extent.

The aspect ratio is a value obtained by dividing the average fiber length by the average fiber width. It is considered that a larger aspect ratio increases the number of caught portions in the resin to improve the reinforcing effect, but reduces the ductility of the resin because of the many caught portions. Note that it is known that when an inorganic filler is kneaded with a resin, a larger aspect ratio of the filler makes the bending strength higher, but significantly reduces elongation.

The crystallinity of the microfiber cellulose is preferably 50% or more, more preferably 55% or more, and particularly preferably 60% or more. When the crystallinity is less than 50%, the compatibility with the resin is improved, but the strength of the fibers themselves is lowered, and therefore a resin composition reinforcing effect tends to be poor.

Meanwhile, the crystallinity of the microfiber cellulose is preferably 90% or less, more preferably 88% or less, and particularly preferably 86% or less. When the crystallinity exceeds 90%, the ratio of strong intramolecular hydrogen bonds increases and the fibers themselves are rigid, but the compatibility with the resin is reduced, and the resin composition reinforcing effect tends to be poor.

The crystallinity may be arbitrarily adjusted by, for example, selection, pretreatment, and micronization treatment of the raw material fiber.

The pulp viscosity of the microfiber cellulose is preferably 2 cps or more, and more preferably 4 cps or more. When the pulp viscosity is less than 2 cps, in a case where the microfiber cellulose is kneaded with the resin, the aggregation of the microfiber cellulose may not be sufficiently suppressed, and the resin composition reinforcing effect tends to be poor.

The freeness of the microfiber cellulose is preferably 500 cc or less, more preferably 300 cc or less, and particularly preferably 100 cc or less. When the freeness exceeds 500 cc, the fiber width of the microfiber cellulose exceeds 15 μm and the reinforcing effect may not be sufficient.

(Kneading)

The microfiber cellulose obtained by the micronization treatment may be dispersed in an aqueous medium to be temporarily a dispersion. The entire amount of the aqueous medium is particularly preferably water, but an aqueous medium partially containing another liquid having compatibility with water may also be preferably used. As the other liquid, a lower alcohol having 3 or less carbon atoms may be used, for example.

The solid concentration of the dispersion is preferably 1.0% by mass or more, more preferably 1.5% by mass or more, and particularly preferably 2.0% by mass or more. The solid concentration of the dispersion is preferably 70% by mass or less, more preferably 60% by mass or less, and particularly preferably 50% by mass or less.

The microfiber cellulose may be dehydrated and dried prior to kneading with the resin and the like. That is, the dehydration/drying treatment of the microfiber cellulose and the kneading treatment thereof do not have to be performed at the same time, and the microfiber cellulose may be dried at the same time during kneading. The dehydration treatment and the drying treatment may be performed at the same time or separately.

For the dehydration treatment, one or more kinds may be selected for use from the group consisting of, for example, a belt press, a screw press, a filter press, a twin roll, a twin wire former, a valveless filter, a center disk filter, a membrane treatment, a centrifuge, and the like.

For the drying treatment, one or more kinds may be selected for use from the group consisting of, for example, rotary kiln drying, disk drying, air flow drying, medium fluid drying, spray drying, drum drying, screw conveyor drying, paddle drying, single-screw kneading drying, multi-screw kneading drying, vacuum drying, and stirring drying.

A pulverization treatment step may be added after the dehydration/drying treatment step. For the pulverization treatment, one or more kinds may be selected for use from the group consisting of, for example, a bead mill, a kneader, a disperser, a twist mill, a cut mill, and a hammer mill.

The dehydrated/dried microfiber cellulose may be in a powder-like, pellet-like, sheet-like, or the like form. However, the dehydrated/dried microfiber cellulose is preferably in a powder-like form.

When the dehydrated/dried microfiber cellulose is in the powder-like form, the average particle size of the microfiber cellulose is preferably 1 to 10000 μm, more preferably 10 to 5000 μm, and particularly preferably 100 to 1000 μm. When the average particle size exceeds 10000 μm, the microfiber cellulose may not be put in a kneading apparatus because of the large particle size. Meanwhile, when the average particle size is less than 1 μm, energy is required for the pulverization treatment, which is not economical.

When the dehydrated/dried microfiber cellulose is in the powder-like form, the bulk specific gravity of the microfiber cellulose is preferably 0.01 to 1.5, more preferably 0.04 to 1, and particularly preferably 0.1 to 0.5.

A bulk specific gravity exceeding 1.5 means that the specific gravity of the cellulose exceeds 1.5, and therefore it is physically difficult to achieve this. Meanwhile, a bulk specific gravity of less than 0.01 is disadvantageous in terms of transfer cost.

The water content (moisture content) of the dehydrated/dried microfiber cellulose is preferably 0.1% or more, more preferably 1.0% or more, and particularly preferably 10.0% or more. When the moisture content of the microfiber cellulose to be kneaded with the polybasic acid salts is 0.1% or more, the modification of the cellulose fibers with the polybasic acid salts may not proceed, and the obtained composite resin contains the polybasic acid salts. In a case where the additive such as the polybasic acids or the polybasic acid salts is added, when the moisture content of the microfiber cellulose is 0.1% or more, the modification of the cellulose fibers with the additive may not proceed, and the obtained composite resin may contain the additive.

The dehydrated/dried microfiber cellulose may contain a resin. When the dehydrated/dried microfiber cellulose contains a resin, hydrogen bonding between the molecules of the dehydrated/dried microfiber cellulose is hindered, and dispersibility in the resin during kneading may be improved.

The resin contained in the dehydrated/dried microfiber cellulose may be in, for example, a powder-like, pellet-like, or sheet-like form. However, the resin is preferably in a powder-like form (powdered resin).

When the resin is in the powder-like form, the average particle size of the resin powder contained in the dehydrated/dried microfiber cellulose is preferably 1 to 10000 μm, more preferably 10 to 5000 μm, and particularly preferably 100 to 1000 μm. When the average particle size exceeds 10000 μm, the resin may not be put in a kneading apparatus because of the large particle size. Meanwhile, when the average particle size is less than 1 μm, hydrogen bonding between the molecules of the microfiber cellulose may not be hindered because of the fineness. Note that the kind of the resin used here such as the powder resin may be the same as or different from the kind of the resin to be kneaded with the microfiber cellulose (resin as a main raw material), but is preferably the same.

The resin powder having an average particle size of 1 to 10000 μm is preferably mixed in an aqueous dispersion state before dehydration and drying. By mixing the resin powder in an aqueous dispersion state, the resin powder may be uniformly dispersed between the fibers of the microfiber cellulose, and the fibers of the microfiber cellulose may be uniformly dispersed in the composite resin after kneading, further improving the strength physical properties.

The microfiber cellulose obtained as described above is kneaded with the resin to be a kneaded product. During this kneading, the polybasic acid salts, the maleic anhydride-modified polypropylene, and the like are further added. Note that the moisture content of the microfiber cellulose during kneading is important as described above.

As the resin, either a thermoplastic resin or a thermosetting resin may be used.

As the thermoplastic resin, one or more kinds may be selected for use from the group consisting of, for example, polyolefin such as polypropylene (PP) or polyethylene (PE), a polyester resin such as an aliphatic polyester resin or an aromatic polyester resin, a polyacrylic resin such as polystyrene, methacrylate, or acrylate, a polyamide resin, a polycarbonate resin, and a polyacetal resin.

However, at least one of polyolefin and a polyester resin is preferably used. As the polyolefin, polypropylene is preferably used.

As the polypropylene, one or more kinds may be selected for use from the group consisting of a homopolymer, a random polymer, and a block polymer. Furthermore, examples of the polyester resin include an aliphatic polyester resin such as polylactic acid or polycaprolactone, and an aromatic polyester resin such as polyethylene terephthalate. However, a biodegradable polyester resin (also referred to simply as “biodegradable resin”) is preferably used.

As the biodegradable resin, one or more kinds may be selected for use from the group consisting of, for example, a hydroxycarboxylic acid-based aliphatic polyester, a caprolactone-based aliphatic polyester, and a dibasic acid polyester.

As the hydroxycarboxylic acid-based aliphatic polyester, one or more kinds may be selected for use from the group consisting of, for example, a homopolymer of hydroxycarboxylic acid such as lactic acid, malic acid, glucose acid, or 3-hydroxybutyric acid, and a copolymer using at least one of these hydroxycarboxylic acids. However, polylactic acid, a copolymer of lactic acid and any of the above hydroxycarboxylic acids other than lactic acid, polycaprolactone, and a copolymer of at least one of the above hydroxycarboxylic acids and caprolactone are preferably used, and polylactic acid is particularly preferably used.

As this lactic acid, for example, L-lactic acid, D-lactic acid, and the like may be used, and a single kind or a combination of two or more kinds of these lactic acids may be used.

As the caprolactone-based aliphatic polyester, one or more kinds may be selected for use from the group consisting of, for example, a homopolymer of polycaprolactone and a copolymer of polycaprolactone or the like and the above hydroxycarboxylic acid.

As the dibasic acid polyester, one or more kinds may be selected for use from the group consisting of, for example, polybutylene succinate, polyethylene succinate, and polybutylene adipate.

As the biodegradable resin, a single kind or a combination of two or more kinds thereof may be used.

As the thermosetting resin, for example, a phenol resin, a urea resin, a melamine resin, a furan resin, an unsaturated polyester, a diallyl phthalate resin, a vinyl ester resin, an epoxy resin, a polyurethane-based resin, a silicone resin, or a thermosetting polyimide-based resin may be used. A single kind or a combination of two or more kinds these resins may be used.

The resin may contain an inorganic filler preferably at a ratio that does not interfere with thermal recycling.

Examples of the inorganic filler include a simple substance of a metal element belonging to Group I to Group VIII of the Periodic Table, such as Fe, Na, K, Cu, Mg, Ca, Zn, Ba, Al, Ti, or a silicon element, an oxide thereof, a hydroxide thereof, a carbonate thereof, a sulfate thereof, a silicate thereof, a sulfite thereof, and various clay minerals formed of these compounds.

Specific examples thereof include barium sulfate, calcium sulfate, magnesium sulfate, sodium sulfate, calcium sulfite, zinc oxide, silica, heavy calcium carbonate, light calcium carbonate, aluminum borate, alumina, iron oxide, calcium titanate, aluminum hydroxide, magnesium hydroxide, calcium hydroxide, sodium hydroxide, magnesium carbonate, calcium silicate, clay wollastonite, glass beads, glass powder, silica sand, silica stone, quartz powder, diatomaceous earth, white carbon, and glass fiber. A plurality of these inorganic fillers may be contained. An inorganic filler contained in de-inked pulp may be used.

The blending ratio of the microfiber cellulose with respect to the resin is preferably 0.1 to 100 parts by mass, more preferably 1 to 80 parts by mass, and particularly preferably 5 to 60 parts by mass with respect to 100 parts by mass of the resin. However, when the blending ratio of the microfiber cellulose is 0.1 to 100 parts by mass, the strength of a composite resin, particularly the bending strength and the flexural modulus may be significantly improved.

Note that the content ratio between the microfiber cellulose and the resin contained in a finally obtained composite resin is usually the same as the above blending ratio between the microfiber cellulose and the resin.

(Polybasic Acid Salts and the Like)

When the microfiber cellulose and the resin are mixed, in addition to the polybasic acid salts and the maleic anhydride-modified polypropylene, at least one additive selected from the group consisting of polybasic acids, derivatives of polybasic acids, and derivatives of polybasic acid salts may be added.

As the additive such as polybasic acids, for example, one or more kinds may be selected for use from the group consisting of oxalic acids, phthalic acids, malonic acids, succinic acids, glutaric acids, adipic acids, tartaric acids, glutamic acids, sebacic acids, hexafluorosilicic acids, maleic acids, itaconic acids, citraconic acids, citric acids, and the like. However, the additive is preferably at least one of phthalic acid, phthalates, and derivatives of these (phthalic acids).

As the polybasic acid salts, for example, oxalates, malonates, succinates, glutarates, adipates, tartrates, glutamates, sebacates, hexafluorosilicates, maleates, itaconates, citraconates, citrates, phthalates, and derivatives of the phthalates, and the like may be used. When the polybasic acid salts are used, coloring of the obtained resin composition is suppressed and foaming at a high temperature is suppressed as compared with a case where the polybasic acids are used. Note that it is considered that the acid decomposition of the cellulose fibers is suppressed to suppress coloring due to a smaller number of hydrogen ions of carboxyl groups in the polybasic acid salts than in the polybasic acids. In addition, it is considered that the polybasic acids are more easily volatilized at a high temperature and are easily foamed than the polybasic acid salts.

However, as the polybasic acid salts, it is preferable to use at least one of phthalates and derivatives of phthalates. By using phthalates or derivatives thereof, the flexural modulus of the obtained resin composition may be improved.

At this time, the phthalates are preferably at least one selected from the group consisting of potassium hydrogen phthalate, sodium hydrogen phthalate, sodium phthalate, and ammonium phthalate.

Examples of the derivatives of the phthalic acids include phthalic acid, potassium hydrogen phthalate, sodium hydrogen phthalate, sodium phthalate, ammonium phthalate, dimethyl phthalate, diethyl phthalate, diallyl phthalate, diisobutyl phthalate, dinormal hexyl phthalate, dioctyl phthalate, diisononyl phthalate, diisodecyl phthalate, and ditriisodecyl phthalate. Phthalic acid is preferably used, and phthalates are more preferably used.

When the polybasic acid salts such as phthalates are used, coloring of the obtained resin composition is suppressed and foaming at a high temperature is suppressed as compared with a case where the polybasic acids are used. Note that it is considered that the acid decomposition of the cellulose fibers is suppressed to suppress coloring due to a smaller number of hydrogen ions of carboxyl groups in the polybasic acid salts than in the polybasic acids. In addition, it is considered that the polybasic acids are more easily volatilized at a high temperature and is easily foamed than the polybasic acid salts. Furthermore, when phthalates and the derivatives of phthalates are used as the polybasic acid salts, the flexural modulus of the obtained resin composition is improved.

As the polybasic anhydrides, one or more kinds may be selected for use from the group consisting of, for example, maleic anhydrides, phthalic anhydrides, itaconic anhydrides, citraconic anhydrides, and citric anhydrides. However, maleic anhydrides are preferably used, and phthalic anhydrides are more preferably used.

Examples of the phthalic anhydrides include phthalic anhydride, tetrahydrophthalic anhydride, methyltetrahydrophthalic anhydride, methylhexahydrophthalic anhydride, hydroxyphthalic anhydride, hexahydrophthalic anhydride, 4-ethynylphthalic anhydride, and 4-phenylethynyl phthalic anhydride. However, phthalic anhydride is preferably used.

A main purpose of the present embodiment is not to modify the microfiber cellulose using the polybasic acid salts (to replace a part of hydroxyl groups with specific functional groups). In the present embodiment, the polybasic acid salts are used as a compatibilizer, thereby (improvement of compatibility) improving the strength or the like of the obtained composite resin. In this regard, when the polybasic acid salts do not modify the cellulose fibers, the quality of the obtained composite resin is stabilized.

However, in the present embodiment, a part of the polybasic acid salts may modify the microfiber cellulose. When the polybasic acid salts modify the cellulose fibers, a part of hydroxyl groups is replaced with a predetermined functional group, and the compatibility between the microfiber cellulose and the resin is improved.

When the cellulose fibers are modified with a part of the additive such as the polybasic acids instead of simple inclusion of the additive, a part of hydroxyl groups of the cellulose fibers is replaced with a predetermined functional group, and the compatibility between the microfiber cellulose and the resin is further improved. However, even in the case of simple inclusion of the additive such as the polybasic acids, the additive functions as a compatibilizer and therefore improves the compatibility. As a result, the strength of the obtained fibrous cellulose composite resin, particularly the bending strength thereof is improved.

Note that when the additive such as the polybasic acids functions as a compatibilizer, the degree of progress of modification of the cellulose fibers does not matter, and therefore the quality of the obtained composite resin is stabilized. However, it is necessary to pay attention to the moisture content of the microfiber cellulose during kneading (this point is as described above), for example, such that the cellulose fibers are not excessively modified.

The modification of the microfiber cellulose with the polybasic acid salts is preferably performed such that a part of hydroxyl groups of the cellulose constituting the fibers is replaced with a functional group represented by the following structural formula.

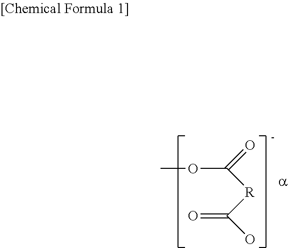

R in the structural formula is any one of: a linear, branched, or cyclic saturated hydrocarbon group or derivatives thereof; a linear, branched, or cyclic unsaturated hydrocarbon group or derivatives thereof; and an aromatic group or derivatives thereof. α is a mono- or higher valent cation made of an organic substance or an inorganic substance.

The modification of the microfiber cellulose with the additive is preferably performed such that a part of hydroxyl groups of the cellulose constituting the fibers is replaced with a functional group represented by the following structural formula (1) or (2).

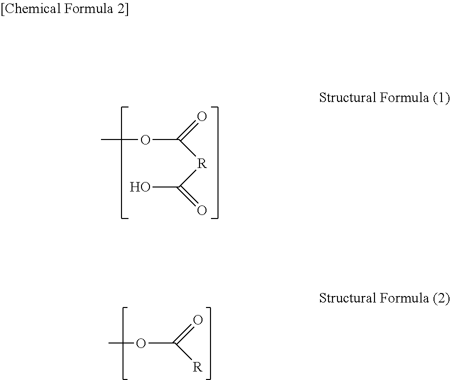

R in the structural formulas is any one of: a linear, branched, or cyclic saturated hydrocarbon group or derivatives thereof; a linear, branched, or cyclic unsaturated hydrocarbon group or derivatives thereof; and an aromatic group or derivatives thereof.

For the kneading treatment, one or more kinds may be selected for use from the group consisting of, for example, a single-screw kneader, a multi-screw kneader having two or more screws, a mixing roll, a kneader, a roll mill, a Banbury mixer, a screw press, and a disperser. Among these, a multi-screw kneader having two or more screws is preferably used. Two or more multi-screw kneaders each having two or more screws may be used in parallel or in series.

The temperature of the kneading treatment is equal to or higher than the glass transition point of the resin and varies depending on the kind of the resin, but is preferably 80 to 280° C., more preferably 90 to 260° C., and more preferably 100 to 240° C.

The blending ratio of the additive such as the polybasic acid salts or the polybasic acids with respect to 100 parts by mass of the microfiber cellulose is preferably 0.1 to 1000 parts by mass, more preferably 1 to 500 parts by mass, and particularly preferably 10 to 200 parts by mass. When the blending ratio of the polybasic acid salts is less than 0.1 parts by mass, a sufficient reinforcing effect cannot be obtained. Meanwhile, when the blending ratio of the polybasic acid salts exceeds 1000 parts by mass, a reinforcing effect reaches a plateau.

(Second Additive: Ethylene Glycol and the Like)

When the microfiber cellulose and the resin are mixed, in addition to the additive such as the polybasic acid salts or polybasic acids, at least one additive (second additive) selected from the group consisting of ethylene glycol, derivatives of ethylene glycol, ethylene glycol polymers, and derivatives of the ethylene glycol polymers may be added. By adding this second additive, the dispersibility of the microfiber cellulose is significantly improved. In this regard, the present inventors have found that when the cellulose fiber is cellulose nanofiber, the dispersibility of the cellulose fiber is not improved. In this regard, it is presumed that the second additive enters a space between fibers of the microfiber cellulose to suppress aggregation thereof in the resin, thereby improving the dispersibility. However, since the specific surface area of the cellulose nanofibers is significantly larger than that of the microfiber cellulose, it is presumed that even when the second additive is excessively added, the second additive does not enter a space between the cellulose nanofibers.

The amount of the second additive added is preferably 0.1 to 1000 parts by mass, more preferably 1 to 500 parts by mass, and particularly preferably 10 to 200 parts by mass with respect to 100 parts by mass of the microfiber cellulose. When the amount of the second additive added is less than 0.1 parts by mass, the second additive does not contribute to improvement of the dispersibility of the microfiber cellulose. Meanwhile, when the amount of the second additive added exceeds 1000 parts by mass, the second additive is excessively added and decreases the resin strength conversely.

The molecular weight of the second additive is preferably 1 to 20000, more preferably 10 to 4000, and particularly preferably 100 to 2000. It is physically impossible for the molecular weight of the second additive to fall below 1. Meanwhile, when the molecular weight of the second additive exceeds 20000, the second additive is bulky and cannot enter a space between fibers of the microfiber cellulose.

(Maleic Anhydride-Modified Polypropylene)

When the microfiber cellulose and the resin are mixed, it is also preferable to add maleic anhydride-modified polypropylene (MAPP). The addition of maleic anhydride-modified polypropylene improves the strength of the obtained resin composition, particularly the bending strength thereof.

The amount of the maleic anhydride-modified polypropylene added is preferably 0.1 to 1000 parts by mass, more preferably 1 to 500 parts by mass, and particularly preferably 10 to 200 parts by mass with respect to 100 parts by mass of the microfiber cellulose. When the amount of maleic anhydride-modified polypropylene added is less than 0.1 parts by mass, the strength is not sufficiently improved. Meanwhile, when the amount of maleic anhydride-modified polypropylene added exceeds 1000 parts by mass, the maleic anhydride-modified polypropylene is excessively added, and the strength tends to be lowered.

The weight average molecular weight of the maleic anhydride-modified polypropylene is 1000 to 100000, and preferably 3000 to 50000.

The acid value of the maleic anhydride-modified polypropylene is preferably 0.5 mgKOH/g or more and 100 mgKOH/g or less, and more preferably 1 mgKOH/g or more and 50 mgKOH/g or less.

(Other Compositions)

To the microfiber cellulose, one or more kinds selected from the group consisting of various fine fibers called cellulose nanofiber, microfibril cellulose, microfibrillar fine fiber, microfilament cellulose, microfibrillated cellulose, and super microfibril cellulose may be added, or the microfiber cellulose may contain these fine fibers. In addition, fibers obtained by further micronizing these fine fibers may be added to the microfiber cellulose, or the microfiber cellulose may contain these fibers. However, the ratio of the microfiber cellulose in the entire raw material fiber needs to be 10% by mass or more, preferably 30% by mass or more, and more preferably 60% by mass or more.

In addition to the above, fibers derived from plant materials obtained from various plants such as kenaf, jute hemp, manila hemp, sisal hemp, Diplomorpha sikokiana, paper birch, Broussonetia papyrifera, banana, pineapple, coconut, corn, sugar cane, bagasse, palm, papyrus, reed, esparto, survival grass, wheat, rice, bamboo, various kinds of softwood (cedar, cypress, and the like), hardwood, and cotton may be added to the microfiber cellulose, or the microfiber cellulose may contain these fibers.

As the raw material of the fibrous cellulose composite resin, in addition to the microfiber cellulose, the resin, the polybasic acid salts, and the above-described additive, one or more kinds can be selected from the group consisting of, for example, additives such as an antistatic agent, a flame retardant, an antibacterial agent, a colorant, a radical scavenger, and a foaming agent, and used as long as these do not interfere with the effect of the present invention.

These raw materials may be mixed with the dispersion of the microfiber cellulose, may be kneaded together while the microfiber cellulose is kneaded with the resin, may be kneaded with the kneaded product, or may be kneaded by another method. However, these raw materials are preferably kneaded together while the microfiber cellulose is kneaded with the resin from a viewpoint of manufacturing efficiency.

(Molding Treatment)

Preferably, the microfiber cellulose and the resin (kneaded product) are kneaded again if necessary, and then molded into a desired shape. Note that although the microfiber cellulose is dispersed in the kneaded product, molding processability is excellent.

The size, thickness, shape, and the like of the molding are not particularly limited, and may be, for example, in a sheet-like, pellet-like, powder-like, or fibrous form.

The temperature during the molding treatment is equal to or higher than the glass transition point of the resin and varies depending on the kind of the resin, but is preferably 80 to 280° C., more preferably 90 to 260° C., and particularly preferably 100 to 240° C.

As an apparatus for the molding treatment, one or more kinds may be selected for use from the group consisting of, for example, an injection molding machine, a blow molding machine, a hollow molding machine, a blow molding machine, a compression molding machine, an extrusion molding machine, a vacuum molding machine, and a pressure molding machine.

The molding treatment may be performed by a known molding method, for example, by die molding, injection molding, extrusion molding, blow molding, or foam molding. The kneaded product may be spun into a fibrous shape, mixed with the above-described plant material or the like, and formed into a mat shape or a board shape. Mixing may be performed by, for example, a method for simultaneously depositing the kneaded product and the plant material or the like by air-laying.

Note that this molding treatment may be performed following the kneading treatment, or may be performed by once cooling the kneaded product, forming the kneaded product into chips using a crusher or the like, and then putting the chips into a molding machine such as an extrusion molding machine or an injection molding machine.

(Definition of Terms, Measurement Method, and the Like)

The terms used herein are as follows unless otherwise specified.

(Average Fiber Diameter) 100 ml of an aqueous dispersion of a microfiber cellulose having a solid concentration of 0.01 to 0.1% by mass is filtered through a Teflon (registered trademark) membrane filter, and solvent substitution is performed once with 100 ml of ethanol and three times with 20 ml of t-butanol. Next, the resulting product is lyophilized and coated with osmium to obtain a sample. An electron microscope SEM image of this sample is observed at a magnification of 5000, 10000, or 30000 depending on the width of the fibers constituting the sample. Specifically, two diagonals are drawn on the observation image, and three straight lines passing the intersection of the diagonals are arbitrarily drawn. Furthermore, the widths of 100 fibers in total intersecting the three straight lines are visually measured. Then, the median diameter of the measured values is taken as the average fiber diameter.

(Average Fiber Length)

The length of each fiber is visually measured in a manner similar to the case of the average fiber diameter. The median diameter of the measured values is taken as the average fiber length.

(Fiber Analysis)

The ratio of fibers each having a length of 0.2 mm or less and the percentage of fibrillation are measured with a fiber analyzer “FS5” manufactured by Valmet Corporation.

(Aspect Ratio)

The aspect ratio is a value obtained by dividing the average fiber length by the average fiber width (diameter).

(Crystallinity)

The crystallinity is a value measured by an X-ray diffraction method in accordance with JIS-K0131 (1996) “General rules for X-ray diffraction analysis”. Note that the microfiber cellulose has an amorphous portion and a crystalline portion, and the crystallinity means the ratio of the crystalline portion in the entire microfiber cellulose.

(Pulp Viscosity)

The pulp viscosity is measured in accordance with JIS-P8215 (1998). Note that the higher the pulp viscosity, the higher the degree of polymerization of the microfiber cellulose.

(Freeness)

The freeness is a value measured in accordance with JIS P8121-2: 2012.

(Moisture Content (Water Content))

The water content of fibers is a value calculated by the following formula, in which the mass at the time when a sample is held at 105° C. for six hours or more using a constant temperature dryer and no change in mass is observed is taken as the mass after drying.

Fiber water content (%) =[(mass before drying - mass after drying)/mass before drying]×100

### EXAMPLES

Next, Examples of the present invention will be described.

To 365 g of an aqueous dispersion of microfiber cellulose having a solid concentration of 2.75% by weight, 7 g of sodium phthalate and 83 g of polypropylene powder were added, and the resulting mixture was heated and dried at 105° C. to obtain a fine cellulose fiber mixture. The microfiber cellulose mixture had a moisture content of less than 10%.

Next, the obtained fine cellulose fiber mixture was kneaded with a twin-screw kneader at 180° C. at 200 rpm to obtain a microfiber cellulose composite resin. This microfiber cellulose composite resin was cut with a pelleter into a cylindrical shape having a diameter of 2 mm and a length of 2 mm, and injection-molded into a rectangular parallelepiped test piece (length 59 mm, width 9.6 mm, thickness 3.8 mm) at 180° C. This test was performed a plurality of times by changing the kinds of various mixing materials, mixing ratios thereof, and the like. Details thereof are as illustrated in Table 1.

The flexural modulus and coloring of the obtained test pieces were examined, and results thereof are illustrated in Table 1. Note that methods for evaluating the flexural modulus and the coloring are as follows.

(Bending Test)

Measurement was performed in accordance with JIS K7171: 2008. In Table, the results are illustrated according to the following criteria.

o: When the flexural modulus of the composite resin (ratio) is 1.4 times or more with respect to the flexural modulus of the resin itself being 1

x: When the flexural modulus of the composite resin (ratio) is less than 1.4 times with respect to the flexural modulus of the resin itself being 1

(Coloring)

o: When the color is visually white to beige

x: When the color is visually brown to black

TABLE 1

| | | | Microfiber cellulose | | | | |
|---|---|---|---|---|---|---|---|
| | Microfiber cellulose | | | Average | Percentage | Bending test | |
| | composite resin | | Average fiber | fiber | of | evaluation | Coloring |
| | MFC:Chemical:PP | Chemical | width | length | fibrillation | — | — |
| Example 1 | 10:2:88 | Sodium | 0.1 μm or more | 1.60 mm | 2.49 | ○ | ○ |
| | | phthalate | | | | | |
| Example 2 | 10:4:86 | Sodium | 0.1 μm or more | 1.60 mm | 2.49 | ○ | ○ |
| | | phthalate | | | | | |
| Example 3 | 10:7:83 | Sodium | 0.1 μm or more | 1.60 mm | 2.49 | ○ | ○ |
| | | phthalate | | | | | |
| Example 4 | 10:9:81 | Sodium | 0.1 μm or more | 1.60 mm | 2.49 | ○ | ○ |
| | | phthalate | | | | | |
| Example 5 | 10:7:83 | Potassium | 0.1 μm or more | 0.16 mm | 10.17 | ○ | ○ |
| | | hydrogen | | | | | |
| | | phthalate | | | | | |
| Example 6 | 10:7:83 | Sodium | 0.1 μm or more | 0.16 mm | 10.17 | ○ | ○ |
| | | phthalate | | | | | |
| Comparative | 10:7:83 | Sodium | less than 0.1 μm | — | — | x | ○ |
| Example 1 | | phthalate | | | | | |
| Comparative | 10:7:83 | Phthalic | 0.1 μm or more | 0.16 mm | 10.17 | ○ | x |
| Example 2 | | acid | | | | | |
| Comparative | 10:0:90 | — | 0.1 μm or more | 0.16 mm | 10.17 | x | ○ |
| Example 3 | | | | | | | |

Next, another Example of the present invention will be described.

To 365 g of an aqueous dispersion of microfiber cellulose having a solid concentration of 2.75% by weight, 1 g of maleic anhydride-modified polypropylene, 7 g of phthalic acid, 3 g of polyethylene glycol (400), and 79 g of polypropylene powder were added, and the resulting mixture was heated and dried at 105° C. to obtain a mixture of fibrous cellulose and the resin. The mixture had a moisture content of less than 10%.

Next, the mixture was kneaded with a twin-screw kneader at 180° C. at 200 rpm to obtain a fibrous cellulose composite resin. This composite resin was cut with a pelleter into a cylindrical shape having a diameter of 2 mm and a length of 2 mm, and injection-molded into a rectangular parallelepiped test piece (length 59 mm, width 9.6 mm, thickness 3.8 mm) at 180° C. This test was performed a plurality of times by changing the kinds of various mixing materials, mixing ratios thereof, and the like. Details thereof are as illustrated in Table 2.

The obtained test pieces were subjected to bending test evaluation, and the results thereof are illustrated in Table 2. The bending test evaluation was performed as follows.

Measurement was performed in accordance with JIS K7171: 2008, and the results thereof are illustrated according to the following criteria.

o: When the flexural modulus of the composite resin (ratio) is 1.5 times or more with the flexural modulus of the resin itself being 1

x: When the flexural modulus of the composite resin (ratio) is less than 1.5 times with the flexural modulus of the resin itself being 1

TABLE 2

| | Microfiber cellulose composite resin | | | | Microfiber cellulose | | | Bending |
|---|---|---|---|---|---|---|---|---|
| | MFC:Chemical | | | | Average | Average | Percentage | test |
| | 1:Chemical 2: | | | | fiber | fiber | of | evaluation |
| | Chemical 3:PP | Chemical 1 | Chemical 2 | Chemical 3 | width | length | fibrillation | — |
| Example 7 | 10:1:7:3:79 | Maleic | Phthalic | Polyethylene | 0.1 μm or | 1.60 mm | 2.49 | ○ |
| | | anhydride- | acid | glycol 400 | more | | | |
| | | modified | | | | | | |
| | | polypropylene | | | | | | |
| Example 8 | 10:3:7:3:77 | Maleic | Phthalic | Polyethylene | 0.1 μm or | 1.60 mm | 2.49 | ○ |
| | | anhydride- | acid | glycol 400 | more | | | |
| | | modified | | | | | | |
| | | polypropylene | | | | | | |
| Example 9 | 10:5:7:3:75 | Maleic | Phthalic | Polyethylene | 0.1 μm or | 1.60 mm | 2.49 | ○ |
| | | anhydride- | acid | glycol 400 | more | | | |
| | | modified | | | | | | |
| | | polypropylene | | | | | | |
| Example 10 | 10:10:7:3:70 | Maleic | Phthalic | Polyethylene | 0.1 μm or | 1.60 mm | 2.49 | ○ |
| | | anhydride- | acid | glycol 400 | more | | | |
| | | modified | | | | | | |
| | | polypropylene | | | | | | |
| Example 11 | 10:5:7:3:75 | Maleic | Potassium | Polyethylene | 0.1 μm or | 0.16 mm | 10.17 | ○ |
| | | anhydride- | hydrogen | glycol 400 | more | | | |
| | | modified | phthalate | | | | | |
| | | polypropylene | | | | | | |
| Example 12 | 10:5:7:3:75 | Maleic | Phthalic | Polyethylene | 0.1 μm or | 0.16 mm | 10.17 | ○ |
| | | anhydride- | acid | glycol 400 | more | | | |
| | | modified | | | | | | |
| | | polypropylene | | | | | | |
| Comparative | 10:5:7:3:75 | Maleic | Phthalic | Polyethylene | less than | — | — | x |
| Example 4 | | anhydride- | acid | glycol 400 | 0.1 μm | | | |
| | | modified | | | | | | |
| | | polypropylene | | | | | | |
| Comparative | 10:0:0:90 | — | — | — | 0.1 μm or | 1.60 mm | 2.49 | x |
| Example 5 | | | | | more | | | |

### INDUSTRIAL APPLICABILITY

The present invention may be used as a fibrous cellulose composite resin and a method for manufacturing the same.

1. A fibrous cellulose composite resin comprising:
microfiber cellulose having an average fiber width of 0.1 μm or more; a resin; and a polybasic acid salt.

2. The fibrous cellulose composite resin according to claim 1,
wherein the microfiber cellulose has an average fiber length of 0.02 to 3.0 mm and a percentage of fibrillation of 1.0 to 30%.

3. The fibrous cellulose composite resin according to claim 1, wherein the polybasic acid salt is at least one of a phthalate and a derivative of a phthalate.

4. The fibrous cellulose composite resin according to claim 3,
wherein the phthalate is at least one selected from the group consisting of potassium hydrogen phthalate, sodium hydrogen phthalate, sodium phthalate, and ammonium phthalate.

5. The fibrous cellulose composite resin according to claim 1,
wherein a part of the polybasic acid salt has modified the microfiber cellulose.

6. A method for manufacturing a fibrous cellulose composite resin, the method comprising:
defibrating raw material fibers into microfiber cellulose within a range where the microfiber cellulose has an average fiber width of 0.1 μm or more; and
kneading this microfiber cellulose, a resin, and a polybasic acid salt.

7. The fibrous cellulose composite resin according to claim 1, comprising maleic anhydride-modified polypropylene.

8. The fibrous cellulose composite resin according to claim 7,
wherein a ratio of the maleic anhydride-modified polypropylene with respect to 100 parts by mass of the microfiber cellulose is 0.1 to 1000 parts by mass.

9. The fibrous cellulose composite resin according to claim 1, comprising
at least one selected from the group consisting of a polybasic acid, a derivative of a polybasic acid, and a derivative of a polybasic acid salt.

10. The fibrous cellulose composite resin according to claim 9,
wherein the microfiber cellulose is modified with any of the polybasic acid, the derivative of polybasic acid, and the derivative of polybasic acid salt.

11. The fibrous cellulose composite resin according to claim 9,
wherein the polybasic acid is phthalic acid, and the polybasic acid salt is a phthalate.

12. The fibrous cellulose composite resin according to claim 2,
wherein the polybasic acid salt is at least one of a phthalate and a derivative of a phthalate.

13. The fibrous cellulose composite resin according to claim 2,
wherein a part of the polybasic acid salt has modified the microfiber cellulose.

14. The fibrous cellulose composite resin according to claim 3,
wherein a part of the polybasic acid salt has modified the microfiber cellulose.

15. The fibrous cellulose composite resin according to claim 4,
wherein a part of the polybasic acid salt has modified the microfiber cellulose.
